(19) United States
(12) Patent Application Publication
(10) Pub. No.: US 2025/0200917 A1
(43) Pub. Date: Jun. 19, 2025

(54) SYSTEM AND METHOD FOR PROVIDING STORE INFORMATION BASED ON DIGITAL TWIN

(71) Applicant: MAZE INC., Hanam-si, Gyeonggi-do (KR)

(72) Inventor: Ki Sun SONG, Hanam-si (KR)

(73) Assignee: MAZE INC., Hanam-si, Gyeonggi-do (KR)

(21) Appl. No.: 18/846,373

(22) PCT Filed: Mar. 24, 2023
(86) PCT No.: PCT/KR2023/003914

§ 371 Date: Sep. 12, 2024

(30) Foreign Application Priority Data
Mar. 24, 2022 (KR) 10-2022-0036961

(51) Int. Cl. G06T 19/20; G06Q 30/0601

(52) U.S. Cl. CPC G06T 19/20; G06Q 30/0643; G06T 2219/2004; G06T 2219/2012; G06T 2219/2021

(57) ABSTRACT

A system and method for providing store information based on a digital twin are provided. A system for providing store information based on a digital twin includes: a store server configured to collect information related to an interior of a store; a server for providing store information configured to generate virtual space information for the store based on a digital twin by reflecting the collected information, in order to provide information about the store through a digital twin service, based on the information collected from the store server; and a first user terminal configured to receive the virtual space information from the server for providing store information and display the virtual space information on a display.

### TECHNICAL FIELD

Disclosed relates to a system and method for providing store information based on a digital twin.

### BACKGROUND ART

Information regarding cafes located within a nearby area centered around the location of the customer terminal may be provided to customers, bridging the gap between cafes that wish to attract customers and customers seeking cafes that match their preferences. For example, if cafe information is pre-registered in an online map service, after the customer terminal accesses the online map service, the information regarding cafes within a predetermined range from the customer's location, as measured by the GPS (Global Positioning System) module installed on the customer terminal, may be displayed on the map or listed on the screen of the customer terminal, thereby providing information about cafes around the customer.

### DISCLOSURE

### Technical Problems to Solve

The present disclosure addresses the need for a system and method for providing store information based on a digital twin capable of reflecting real-world stores in a metaverse-based virtual space in real time, thereby enabling the selection of a desired store without the need for physical visits.

### Solution to Solve Technical Problems

A system for providing store information based on a digital twin according to an embodiment may include: a store server configured to collect information related to an interior of a store; a server for providing store information configured to generate virtual space information for the store based on a digital twin by reflecting the collected information, in order to provide information about the store through a digital twin service, based on the information collected from the store server; and a first user terminal configured to receive the virtual space information from the server for providing store information and display the virtual space information on a display.

In some embodiments, the virtual space information may be represented as a three-dimensional virtual space on the first user terminal, and the virtual space information may be updated in real time to reflect changes in shapes and arrangements of store internal elements constituting the store.

In some embodiments, the first user terminal may be configured to display a notification based on a comparison between a predetermined threshold value for the virtual space information and a quantified value of the amount of change in the virtual space information.

In some embodiments, the store interior elements may include a floor, a wall, and a ceiling constituting the store, and a table and a chair arranged within the store.

In some embodiments, the server for providing store information may be configured to: calculate an usage rate of the store interior elements based on information collected from the store server; and modify and represent geometric shape or color of the store interior elements represented in the three-dimensional virtual space according to the value of the usage rate.

In some embodiments, the store server may be configured to calculate an usage rate of the store interior elements and transmit the usage rate to the server for providing store information, and the server for providing store information may be configured to modify and represent geometric shape or color of the store interior elements represented in the three-dimensional virtual space according to the value of the usage rate received from the store server.

In some embodiments, the store server may be configured to transmit noise level measurement data for the store to the server for providing store information, and the server for providing store information may be configured to modify and represent geometric shape or color of the store interior elements represented in the three-dimensional virtual space according to the value of the noise level measurement data.

In some embodiments, the system for providing store information based on a digital twin may further include a second user terminal configured to receive the virtual space information from the server for providing store information and generate interior modification design data by changing the shapes and arrangements of the store interior elements based on the virtual space information, and the second user terminal may be configured to transmit the interior modification design data to the store server.

In some embodiments, when the store server receives the interior modification design data from the second user terminal, the store server may be configured to wait for user input, when the user input is a first value, the store server may be configured to transmit the interior modification design data to the server for providing store information, the server for providing store information may be configured to generate virtual space change schedule information for the store based on the interior modification design data using a digital twin and transmit the virtual space change schedule information to the first user terminal, and the first user terminal may be configured to display the virtual space change schedule information along with the virtual space information.

In some embodiments, when the user input changes from the first value to a second value different from the first value, the store server may be configured to transmit an interior change completion notification message to the server for providing store information, and the server for providing store information may be configured to discard the virtual space change schedule information in response to the interior change completion notification message.

In some embodiments, when the user input is a third value different from the first value, the store server may be configured to discard the interior modification design data.

In some embodiments, the first user terminal may be configured to arrange the virtual space information in a first row or a first column, and arrange the virtual space change schedule information in a second row or a second column in parallel.

In some embodiments, the first user terminal may be configured to display the virtual space information, when a click or touch input occurs on the virtual space information, the first user terminal may be configured to switch and display the virtual space information as the virtual space change schedule information, and when the click or touch input ends, the first user terminal may be configured to switch and display the virtual space change schedule information as the virtual space information.

In some embodiments, the store server may include: a first store server configured to collect information related to an interior of a first store; and a second store server configured to collect information related to an interior of a second store different from the first store, and the server for providing store information may be configured to generate information for multiple stores based on a digital twin, using the information collected from the first store server and the second store server, and provide the information to the first user terminal.

A method for providing store information based on a digital twin according to an embodiment may include: collecting information related to an interior of the store; generating virtual space information for the store based on a digital twin by reflecting the collected information, in order to provide information about the store through a digital twin service; and transmitting the virtual space information to a first user terminal.

In some embodiments, the virtual space information may be represented as a three-dimensional virtual space on the first user terminal, and the virtual space information may be updated in real time to reflect changes in shapes and arrangements of store internal elements constituting the store.

In some embodiments, the method for providing store information based on a digital twin may further include: obtaining an usage rate of the store interior elements based on the collected information; and modifying and representing geometric shape or color of the store interior elements represented in the three-dimensional virtual space according to the value of the usage rate.

In some embodiments, the method for providing store information based on a digital twin may further include: obtaining noise level measurement data for the store; and modifying and representing geometric shape or color of the store interior elements represented in the three-dimensional virtual space according to the value of the noise level measurement data.

In some embodiments, obtaining interior modification design data from the server for providing store information, the interior modification design data being based on changes to the shapes and arrangements of the store interior elements in the virtual space information; and generating virtual space change schedule information for the store based on the interior modification design data using a digital twin and transmitting the virtual space change schedule information to the first user terminal.

### Advantageous Effects

A system for providing store information based on a digital twin and a method for providing store information based on a digital twin may be provided, which reflect real-world stores in a metaverse-based virtual space in real time, thereby enabling the selection of a desired store without the need for a physical visit.

### DESCRIPTION OF THE DRAWINGS

FIG. 1 is a diagram illustrating a system for providing store information based on a digital twin according to an embodiment.

FIGS. 2 to 4 are diagrams illustrating operations of a system for providing store information based on a digital twin according to an embodiment.

FIG. 5 is a diagram illustrating a method for providing store information based on a digital twin according to an embodiment.

FIG. 6 is a diagram illustrating a system for providing store information based on a digital twin according to an embodiment.

FIGS. 7 to 9 are diagrams illustrating operations of a system for providing store information based on a digital twin according to an embodiment.

FIG. 10 is a diagram illustrating a computing device according to an embodiment.

### MODE FOR INVENTION

Hereinafter, the embodiments of the present invention will be described in detail with reference to the accompanying drawings so that those skilled in the art to which the present invention pertains can easily implement them. However, the present invention is not limited to the embodiments described herein and may be implemented in various different forms. Moreover, in order to clearly describe the present invention in the drawings, parts irrelevant to the description have been omitted, and similar reference numerals have been used for similar parts throughout the specification.

In the entire specification and claims, when a part is described as “including” a certain component, it means that, unless specifically stated otherwise, the inclusion of other components is not excluded and that other components may be further included.

Furthermore, the terms such as “ . . . part,” “ . . . unit,” and “ . . . module” described in the specification may refer to units capable of processing at least one function or operation as described herein, and these units may be implemented as hardware, software, or a combination of hardware and software.

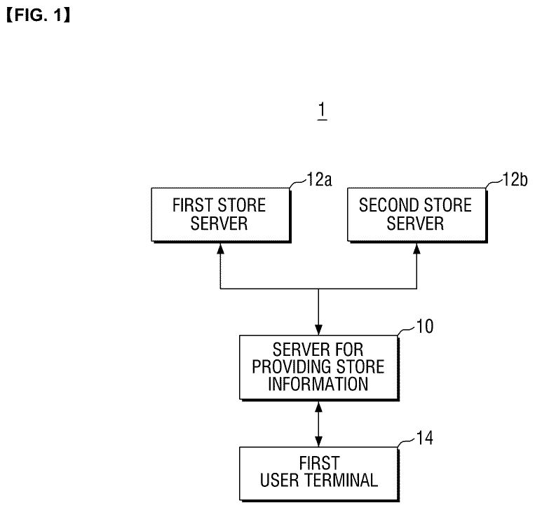

FIG. 1 is a diagram illustrating a system for providing store information based on a digital twin according to an embodiment.

Referring to FIG. 1, a system 1 for providing store information based on a digital twin according to an embodiment may include a server 10 for providing store information, store servers 12a and 12b, and a first user terminal 14.

The server 10 for providing store information may provide information about the stores where the store servers 12a and 12b are located through a digital twin service, based on the information collected from the store servers 12a and 12b. For this purpose, the server 10 for providing store information may generate virtual space information for the stores where the store servers 12a and 12b are located, based on the digital twin, by reflecting the information collected from the store servers 12a and 12b. The virtual space information is information that represents the real-time status of the physical stores.

The store servers 12a and 12b may collect information about the stores where the store servers 12a and 12b are located. Here, the information about the stores may include information related to the store interior, real-time information about visitors in the store, noise information within the store, and the like, but the scope of the present invention is not limited to these examples. Specifically, the first store server 12a may collect information related to the interior of the first store, and the second store server 12b may collect information related to the interior of a second store, which is different from the first store. The server 10 for providing store information may generate information based on a digital twin for multiple stores based on the information collected from the first store server 12a and the second store server 12b and may provide the information to the first user terminal 14.

The first user terminal 14 may receive virtual space information from the server 10 for providing store information and may display it on a display of the first user terminal 14. For example, the first user terminal 14 may visually present the virtual space information by rendering it in real time in a metaverse-based three-dimensional virtual space. Since the virtual space information provided by the server 10 for providing store information is generated based on a digital twin, the virtual space information may be updated to reflect in real time the shapes and arrangements of the internal elements that constitute the store, and according to these changes, the first user terminal 14 may render the updates in the three-dimensional virtual space in real time. In some embodiments, the internal elements of the store may include the floor, walls, and ceiling that constitute the store, as well as tables and chairs arranged within the store.

Accordingly, the first user terminal 14 may receive a plurality of virtual space information corresponding to a plurality of stores from the server 10 for providing store information, and by displaying the plurality of virtual space information on the display, the user of the first user terminal 14 may experience virtual stores that reflect real-time changes in reality, allowing the user to select a store they wish to visit without needing to physically visit the stores displayed by the first user terminal 14.

In some embodiments, the server 10 for providing store information may calculate the usage rate of internal elements of the store based on the information collected from the store servers 12a and 12b, and may represent the geometric shapes of the internal elements in the three-dimensional virtual space by modifying them according to the value of the usage rate. Here, the usage rate may indicate the ratio of the time during which the internal elements of the store are used by store visitors to the total predetermined time. For example, the server 10 for providing store information may calculate the usage rate of chairs or tables arranged within the store during a predetermined period based on the information collected from the store servers 12a and 12b. A high usage rate for a particular chair or table may be interpreted as a high preference by visitors for that chair or table, which may influence the selection of a store that the user of the first user terminal 14 wishes to visit. The server 10 for providing store information may modify and represent the geometric shapes of the chairs or tables in the three-dimensional virtual space according to the value of the usage rate. For example, the size of a chair or table judged to have a high usage rate may be represented larger than that of a chair or table judged to have a low usage rate, or the shape of a chair or table judged to have a high usage rate may be represented with more distortion than that of a chair or table judged to have a low usage rate. Accordingly, the user of the first user terminal 14 may intuitively grasp the usage rate or popularity of the internal elements based solely on the geometric shapes represented in the three-dimensional virtual space.

In some embodiments, the server 10 for providing store information may calculate the usage rate of internal elements of the store based on the information collected from the store servers 12a and 12b, and may represent the colors of the internal elements in the three-dimensional virtual space by modifying them according to the value of the usage rate. For example, the color of a chair or table judged to have a high usage rate may be represented in a different color from that of a chair or table judged to have a low usage rate, or the transparency of a chair or table judged to have a high usage rate may be represented differently from that of a chair or table judged to have a low usage rate. Accordingly, the user of the first user terminal 14 may intuitively grasp the usage rate or popularity of the internal elements based solely on the colors represented in the three-dimensional virtual space.

In some embodiments, the server 10 for providing store information may receive the usage rate of the internal elements of the store from the store servers 12a and 12b. That is, the store servers 12a and 12b may recognize the internal elements of the store, including chairs and tables, from photos or videos captured within the store using cameras, then calculate the usage rate of the recognized chairs or tables over a predetermined period, and transmit this information to the server 10 for providing store information. The server 10 for providing store information may modify and represent geometric shape or colors of at least one of the internal elements of the store represented in the three-dimensional virtual space according to the value of the usage rate received from the store servers 12a and 12b. Accordingly, the user of the first user terminal 14 may intuitively grasp the usage rate or popularity of the internal elements based solely on the geometric shapes and colors represented in the three-dimensional virtual space.

In some embodiments, the store servers 12a and 12b may transmit noise level measurement data for each store to the server 10 for providing store information. The server 10 for providing store information may modify and represent the geometric shapes or modify and represent the colors of the internal elements of the store represented in the three-dimensional virtual space according to the value of the noise level measurement data. For example, the geometric shapes or colors of the floor, walls, and ceiling constituting a space judged to have a high noise level may be represented differently from the geometric shapes or colors of the floor, walls, and ceiling constituting a space judged to have a low noise level. Accordingly, the user of the first user terminal 14 may intuitively grasp the noise level or atmosphere of the space associated with the internal elements based solely on the geometric shapes or colors represented in the three-dimensional virtual space.

In some embodiments, the first user terminal 14 may display a notification based on a comparison between a predetermined threshold value for the virtual space information and a quantified value of the amount of change in the virtual space information. For example, if a threshold value is set, and the quantified value of the amount of change in the geometric shape or the color of the internal elements of the store exceeds the threshold value, a notification may be displayed. For instance, the user of the first user terminal 14 may set a threshold value for stores with a high noise level among the stores displayed by the first user terminal 14. If, over time, the noise level decreases and the quantified value of the amount of change in the geometric shape or the color of the internal elements represented in the virtual space becomes sufficiently significant to exceed the threshold value, a notification may be triggered, allowing the user of the first user terminal 14 to be prompted to select the store with the reduced noise level. Accordingly, the user of the first user terminal 14 may conveniently recognize that the condition within the store they were interested in has reached the desired state, without needing to continuously monitor the store's condition, simply by receiving the notification.

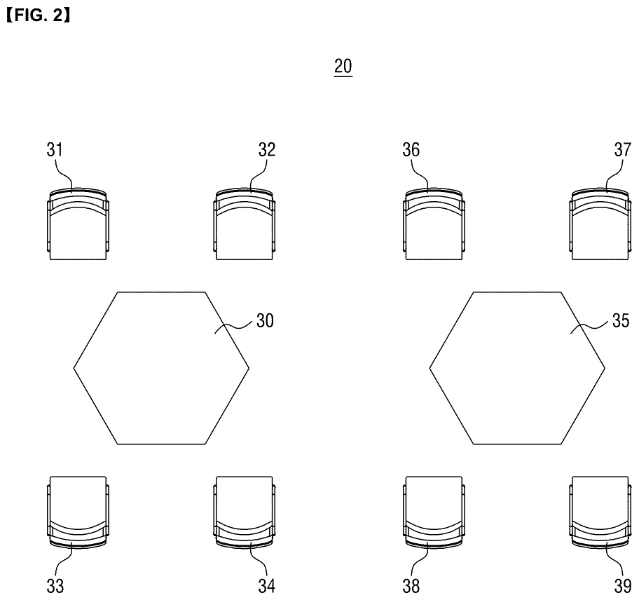

FIGS. 2 to 4 are diagrams illustrating operations of a system for providing store information based on a digital twin according to an embodiment.

Referring to FIG. 2, the first user terminal 14 may visually represent the virtual space information 20 received from the server 10 for providing store information by rendering it in real time on the display of the first user terminal 14. For example, the first user terminal 14 may visually represent the current arrangement of tables 30, 35 and chairs 31-34, 36-39 in the store.

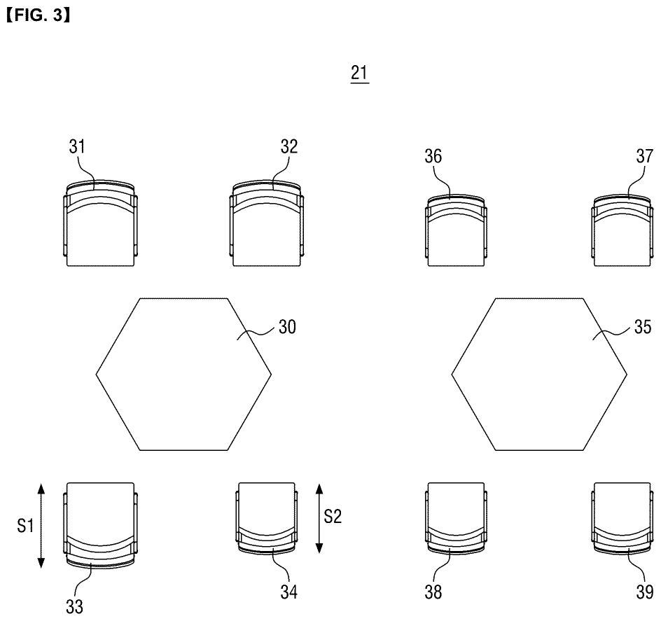

Referring to FIG. 3, the server 10 for providing store information may obtain the usage rate of the internal elements of the store based on the information collected from the store servers 12a and 12b, and may modify the geometric shapes of the internal elements represented in the three-dimensional virtual space according to the value of the usage rate, thereby representing them as virtual space information 21. Alternatively, the server 10 for providing store information may modify the geometric shapes of the internal elements represented in the three-dimensional virtual space based on the noise level measurement data received from the store servers 12a and 12b, thereby representing them as virtual space information 21. For example, a first size S1 of chairs 31, 32, 33 judged to have a high usage rate may be represented larger than a second size S2 of chairs 34, 36, 37, 38, 39 judged to have a low usage rate.

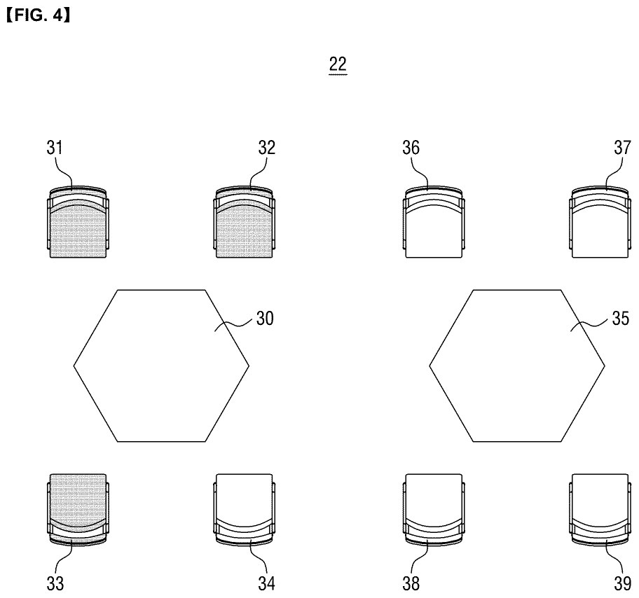

Referring to FIG. 4, the server 10 for providing store information may obtain the usage rate of the internal elements of the store based on the information collected from the store servers 12a and 12b, and may modify the colors of the internal elements represented in the three-dimensional virtual space according to the value of the usage rate, thereby representing them as virtual space information 22. Alternatively, the server 10 for providing store information may modify the colors of the internal elements represented in the three-dimensional virtual space based on the noise level measurement data received from the store servers 12a and 12b, thereby representing them as virtual space information 22. For example, the colors of chairs 31, 32, 33 judged to have a high usage rate may be represented differently from the colors of chairs 34, 36, 37, 38, 39 judged to have a low usage rate.

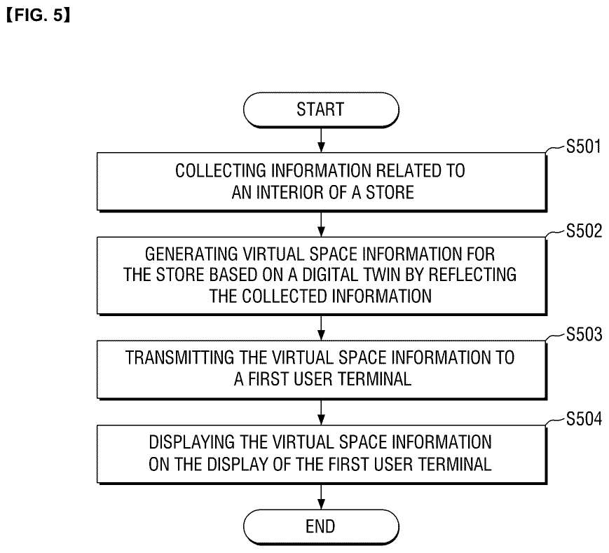

FIG. 5 is a diagram illustrating a method for providing store information based on a digital twin according to an embodiment.

Referring to FIG. 5, a method for providing store information based on a digital twin according to an embodiment may include collecting information related to an interior of a store in step S501, generating virtual space information for the store based on a digital twin by reflecting the collected information in order to provide information about the store through a digital twin service based on the collected information in step S502, transmitting the virtual space information to a first user terminal in step S503, and displaying the virtual space information on the display of the first user terminal in step S504.

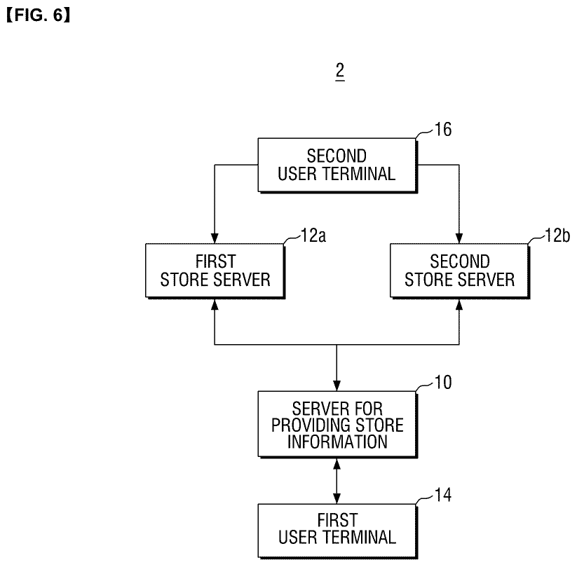

Regarding the more detail of the above method, reference may be made to the previously described explanations in connection with FIGS. 1 to 4 and the explanations to be described later in connection with FIGS. 6 to 9, and therefore, redundant explanations are omitted here.

FIG. 6 is a diagram illustrating a system for providing store information based on a digital twin according to an embodiment.

Referring to FIG. 6, a system 2 for providing store information based on a digital twin according to an embodiment may include a server 10 for providing store information, store servers 12a and 12b, a first user terminal 14, and a second user terminal 16

The server 10 for providing store information may provide information about the stores where the store servers 12a and 12b are located through a digital twin service, based on the information collected from the store servers 12a and 12b. For this purpose, the server 10 for providing store information may generate virtual space information for the stores where the store servers 12a and 12b are located, based on the digital twin, by reflecting the information collected from the store servers 12a and 12b.

The store servers 12a and 12b may collect information about the stores where the store servers 12a and 12b are located. Specifically, the first store server 12a may collect information related to the interior of the first store, and the second store server 12b may collect information related to the interior of a second store, which is different from the first store. The server 10 for providing store information may generate information based on a digital twin for multiple stores, based on the information collected from the first store server 12a and the second store server 12b, and may provide this information to the first user terminal 14.

The first user terminal 14 may receive virtual space information from the server 10 for providing store information and may display it on a display of the first user terminal 14. For example, the first user terminal 14 may visually present the virtual space information by rendering it in real time in a metaverse-based three-dimensional virtual space.

The second user terminal 16 may receive virtual space information from the server 10 for providing store information and may generate interior modification design data that changes the shapes and arrangements of the internal elements of the store based on the virtual space information. For example, the second user terminal 16 may be a terminal used by professionals who provide interior consulting. The professionals may propose changes to the shapes and arrangements of the internal elements of the store based on the virtual space information through the second user terminal 16.

Specifically, the second user terminal 16 may receive virtual space information for a store from the server 10 for providing store information and may display it on the display of the second user terminal 16. Additionally, the second user terminal 16 may provide an editing tool that allows the virtual space information to be edited, enabling a professional to change the shapes and arrangements of the internal elements of the store. The changes to the shapes and arrangements of the internal elements are stored as interior modification design data, and the second user terminal 16 may transmit the interior modification design data to the store servers 12a and 12b. The following description primarily explains the case where the second user terminal 16 transmits the interior modification design data to the store server 12a, but the same description may apply when the second user terminal 16 transmits the interior modification design data to the store server 12b.

When the store server 12a receives the interior modification design data from the second user terminal 16, the store server 12a may wait for user input. For example, the store server 12a may display a notification to the store owner indicating that the interior modification design data has been received and may wait for the store owner's input on whether to accept the proposed changes after the store owner has reviewed the interior modification design data.

For example, if the store owner decides to accept the changes proposed by the professional in the interior modification design data, the input from the store owner may have a first value. When the first value is input into the store server 12a, the store server 12a may transmit the interior modification design data to the server 10 for providing store information. The server 10 for providing store information may generate virtual space change schedule information for the store based on the interior modification design data received from the store server 12a, using a digital twin, and may transmit the virtual space change schedule information to the first user terminal 14. Here, the virtual space change schedule information may represent how the store's interior will be changed or renovated in the future.

The first user terminal 14 may display the virtual space change schedule information reflecting the future planned interior changes on the display, along with the virtual space information reflecting the current interior. Accordingly, the user of the first user terminal 14 may not only experience a virtual store that reflects real-time changes in reality but also preview how the store's interior will be changed in the future. This allows the user to more accurately select the store they wish to visit without needing to physically visit the stores displayed by the first user terminal 14.

In some embodiments, the first user terminal 14 may arrange the virtual space information reflecting the current interior in a first row or a first column, and arrange the virtual space change schedule information reflecting the future planned changes in a second row or a second column in parallel, rendering and displaying each in a three-dimensional virtual space. In some embodiments, the first user terminal 14 may, by default, display the virtual space information reflecting the current interior, and when a click or touch input is detected on the virtual space information, switch to and display the virtual space change schedule information. When the click or touch input ends, the first user terminal 14 may switch back to and display the virtual space information. Accordingly, the user of the first user terminal 14 may directly compare the virtual store reflecting the current reality with the virtual store reflecting the future planned changes in a convenient manner, allowing the user to more accurately select the store they wish to visit.

If the store owner completes the interior changes by accepting the proposals suggested by the professional in the interior modification design data, the store owner may input a second value different from the first value. In other words, if the store owner's input changes from the first value to the second value, the store server 12a may transmit an interior change completion notification message to the server 10 for providing store information. The server 10 for providing store information may discard the virtual space change schedule information in response to the interior change completion notification message. Here, the interior change completion notification message may be information intended to notify that the interior changes within the store have been completed. Accordingly, the first user terminal 14 may stop displaying both the virtual space information reflecting the current interior and the virtual space change schedule information reflecting the future planned interior changes and instead display only the virtual space information reflecting the newly changed interior.

Meanwhile, if the store owner decides not to accept the proposals suggested by the professional in the interior modification design data, the input from the store owner may have a third value different from the first value. In this case, the store server 12a may discard the interior modification design data received from the second user terminal 16.

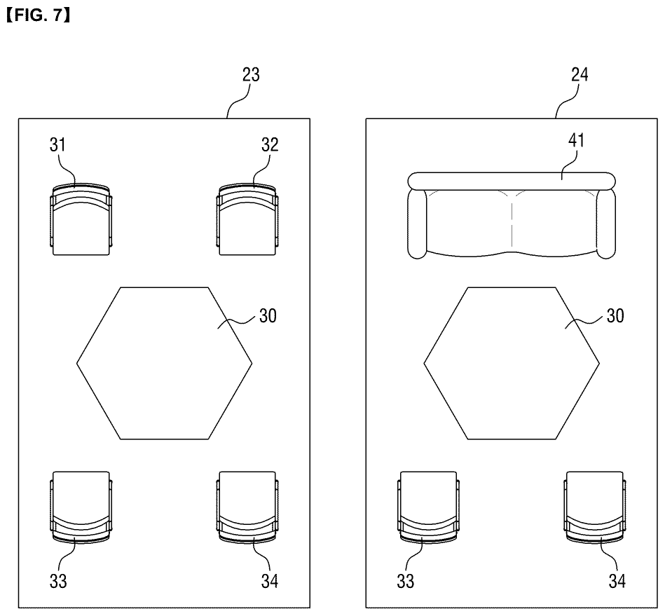

FIGS. 7 to 9 are diagrams illustrating operations of a system for providing store information based on a digital twin according to an embodiment.

Referring to FIG. 7, the first user terminal 14 may render and visually represent on the display both the virtual space information 23 reflecting the current interior, received from the server 10 for providing store information, and the virtual space change schedule information 24 reflecting the future planned interior changes, received from the server 10 for providing store information. For example, the first user terminal 14 may visually represent the current arrangement of the table 30 and chairs 31-34 in the virtual space information 23 and may visually represent the change of chairs 31 and 32 to sofas 41 in the virtual space change schedule information 24. As illustrated, the first user terminal 14 may place the virtual space information 23 reflecting the current interior in the first column and the virtual space change schedule information 24 reflecting the future planned changes in the second column, rendering and displaying each in a three-dimensional virtual space in parallel.

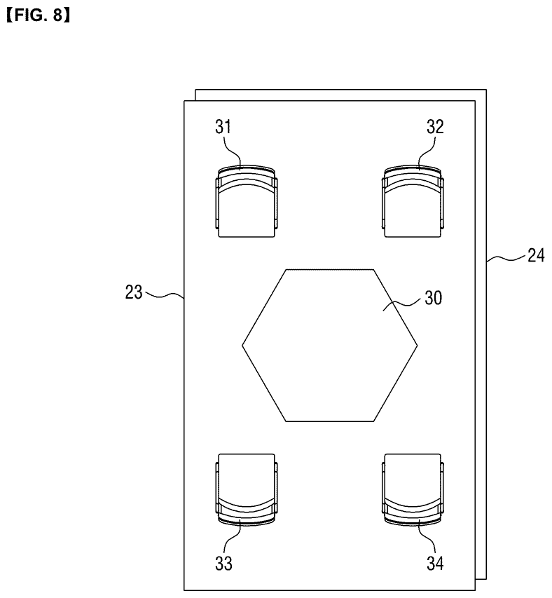

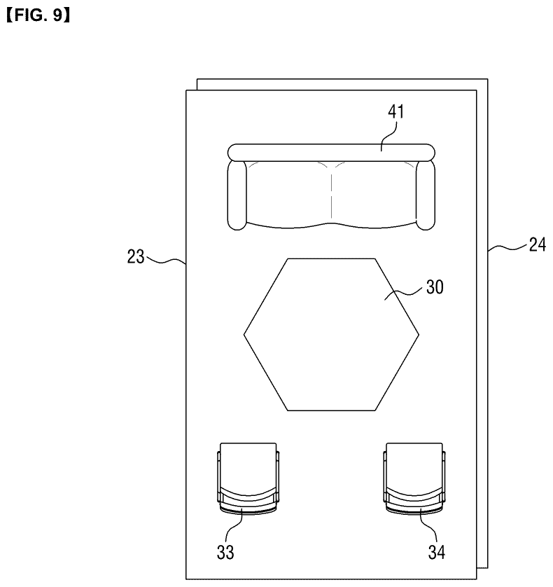

Referring to FIG. 8, the first user terminal 14 may, by default, display the virtual space information 23 reflecting the current interior. Referring to FIG. 9, when a click or touch input occurs on the virtual space information, the first user terminal 14 may switch from the virtual space information 23 to the virtual space change schedule information 24 and display the virtual space change schedule information 24. Referring again to FIG. 8, when the click or touch input ends, the first user terminal 14 may switch back from the virtual space change schedule information 24 to the virtual space information 23 and display the virtual space information 23.

According to the embodiments described so far, the user of the first user terminal 14 may experience a virtual store that reflects real-time changes in reality, allowing the user to select the store they wish to visit without needing to physically visit the stores displayed by the first user terminal 14. In this regard, the user of the first user terminal 14 may intuitively grasp the usage rate or popularity of the internal elements, or the noise level or atmosphere of the space, based solely on the geometric shapes or colors of the internal elements represented in the three-dimensional virtual space. Furthermore, the user of the first user terminal 14 may conveniently recognize that the condition within the store they were interested in has reached the desired state by receiving a notification, without the need to continuously monitor the store's condition until it becomes the desired state.

Furthermore, the user of the first user terminal 14 may not only experience a virtual store that reflects real-time changes in reality, but also preview how the interior of the store will be changed in the future. This allows the user to more accurately select the store they wish to visit without needing to physically visit the stores displayed by the first user terminal 14. Additionally, the user of the first user terminal 14 may directly compare the virtual store reflecting the current reality with the virtual store reflecting the future planned changes in a convenient manner, enabling a more accurate selection of the store they wish to visit.

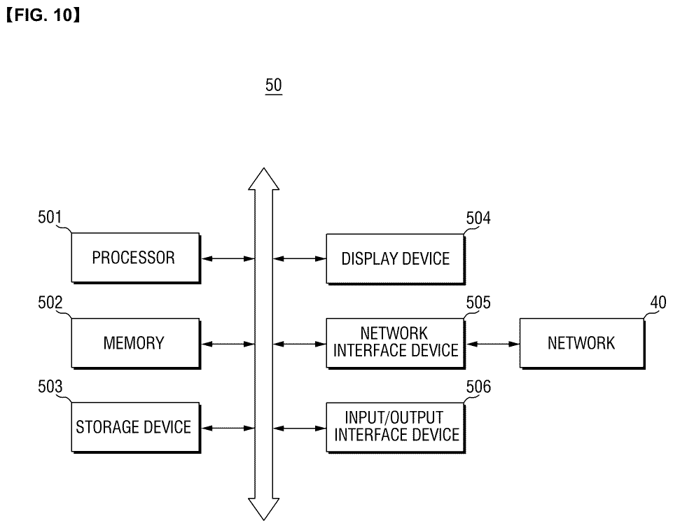

FIG. 10 is a diagram illustrating a computing device according to an embodiment.

Referring to FIG. 10, a system for providing store information based on a digital twin and a method for providing store information based on a digital twin according to the embodiments may be implemented using a computing device 50.

The computing device 50 may include at least one of a processor 501, memory 502, storage device 503, display device 504, network interface device 505 providing access to a network 40 for communication with other entities, and an input/output interface device 506 that provides a user input interface or user output interface, all of which communicate via a bus 509. Of course, the computing device 50 may also include any additional electronic devices necessary to implement the technical concepts described in this specification, even though they are not depicted in FIG. 10.

The processor 501 may be implemented in various forms, such as an Application Processor (AP), Central Processing Unit (CPU), Graphic Processing Unit (GPU), or Neural Processing Unit (NPU), and may be any electronic device capable of executing programs or instructions stored in memory 502 or storage device 503. In particular, the processor 501 may be configured to implement the functions or methods described in connection with FIGS. 1 to 9.

The memory 502 and storage device 503 may include various types of volatile or non-volatile storage media. For example, memory 502 may include ROM (read-only memory) or RAM (random access memory) and may be located either internally or externally to the processor 501, and may be connected to the processor 501 through various means already known. Meanwhile, examples of the storage device 503 include HDD (Hard Disk Drive) or SSD (Solid State Drive), among others. The scope of the present invention is not limited to the elements listed above, which are provided for illustrative purposes.

In some embodiments, at least a portion of the system for providing store information based on a digital twin and the method for providing store information based on a digital twin according to the embodiments may be implemented as a program or software executed on a computing device 50, and such a program or software may be stored on a computer-readable medium.

In some embodiments, at least a portion of the system for providing store information based on a digital twin and the method for providing store information based on a digital twin according to the embodiments may be implemented using hardware or circuits of the computing device 50, or may be implemented as separate hardware or circuits that may be electrically connected to the computing device 50.

The embodiments of the present invention have been described in detail above, but the scope of the present invention is not limited to these descriptions. Various modifications and improvements that utilize the basic concepts of the present invention, as defined in the following claims, and that are made by those skilled in the art to which the present invention pertains, are also within the scope of the present invention.

1. A system for providing store information based on a digital twin comprising:
a store server configured to collect information related to an interior of a store;
a server for providing store information configured to generate virtual space information for the store based on a digital twin by reflecting the collected information, in order to provide information about the store through a digital twin service, based on the information collected from the store server; and
a first user terminal configured to receive the virtual space information from the server for providing store information and display the virtual space information on a display.

2. The system for providing store information based on a digital twin according to claim 1, wherein:
the virtual space information is represented as a three-dimensional virtual space on the first user terminal, and
the virtual space information is updated in real time to reflect changes in shapes and arrangements of store internal elements constituting the store.

3. The system for providing store information based on a digital twin according to claim 2, wherein:
the first user terminal is configured to display a notification based on a comparison between a predetermined threshold value for the virtual space information and a quantified value of the amount of change in the virtual space information.

4. The system for providing store information based on a digital twin according to claim 2, wherein:
the store interior elements include a floor, a wall, and a ceiling constituting the store, and a table and a chair arranged within the store.

5. The system for providing store information based on a digital twin according to claim 2, wherein:
the server for providing store information is configured to:
calculate an usage rate of the store interior elements based on information collected from the store server; and
modify and represent geometric shape or color of the store interior elements represented in the three-dimensional virtual space according to the value of the usage rate.

6. The system for providing store information based on a digital twin according to claim 2, wherein:
the store server is configured to calculate an usage rate of the store interior elements and transmit the usage rate to the server for providing store information, and
the server for providing store information is configured to modify and represent geometric shape or color of the store interior elements represented in the three-dimensional virtual space according to the value of the usage rate received from the store server.

7. The system for providing store information based on a digital twin according to claim 2, wherein:
the store server is configured to transmit noise level measurement data for the store to the server for providing store information, and
the server for providing store information is configured to modify and represent geometric shape or color of the store interior elements represented in the three-dimensional virtual space according to the value of the noise level measurement data.

8. The system for providing store information based on a digital twin according to claim 2, further comprising:
a second user terminal configured to receive the virtual space information from the server for providing store information and generate interior modification design data by changing the shapes and arrangements of the store interior elements based on the virtual space information,
wherein the second user terminal is configured to transmit the interior modification design data to the store server.

9. The system for providing store information based on a digital twin according to claim 8, wherein:
when the store server receives the interior modification design data from the second user terminal, the store server is configured to wait for user input,
when the user input is a first value, the store server is configured to transmit the interior modification design data to the server for providing store information,
the server for providing store information is configured to generate virtual space change schedule information for the store based on the interior modification design data using a digital twin and transmit the virtual space change schedule information to the first user terminal, and
the first user terminal is configured to display the virtual space change schedule information along with the virtual space information.

10. The system for providing store information based on a digital twin according to claim 9, wherein:
when the user input changes from the first value to a second value different from the first value, the store server is configured to transmit an interior change completion notification message to the server for providing store information, and
the server for providing store information is configured to discard the virtual space change schedule information in response to the interior change completion notification message.

11. The system for providing store information based on a digital twin according to claim 9, wherein:
when the user input is a third value different from the first value, the store server is configured to discard the interior modification design data.

12. The system for providing store information based on a digital twin according to claim 9, wherein:
the first user terminal is configured to arrange the virtual space information in a first row or a first column, and arrange the virtual space change schedule information in a second row or a second column in parallel.

13. The system for providing store information based on a digital twin according to claim 9, wherein:
the first user terminal is configured to display the virtual space information,
when a click or touch input occurs on the virtual space information, the first user terminal is configured to switch and display the virtual space information as the virtual space change schedule information, and
when the click or touch input ends, the first user terminal is configured to switch and display the virtual space change schedule information as the virtual space information.

14. The system for providing store information based on a digital twin according to claim 1, wherein:
the store server comprises:
a first store server configured to collect information related to an interior of a first store; and
a second store server configured to collect information related to an interior of a second store different from the first store, and
the server for providing store information is configured to generate information for multiple stores based on a digital twin, using the information collected from the first store server and the second store server, and provide the information to the first user terminal.

15. A method for providing store information based on a digital twin, comprising:
collecting information related to an interior of the store;
generating virtual space information for the store based on a digital twin by reflecting the collected information, in order to provide information about the store through a digital twin service; and
transmitting the virtual space information to a first user terminal.

16. The method for providing store information based on a digital twin according to claim 15, wherein:
the virtual space information is represented as a three-dimensional virtual space on the first user terminal, and
the virtual space information is updated in real time to reflect changes in shapes and arrangements of store internal elements constituting the store.

17. The method for providing store information based on a digital twin according to claim 16, further comprising:
obtaining an usage rate of the store interior elements based on the collected information; and
modifying and representing geometric shape or color of the store interior elements represented in the three-dimensional virtual space according to the value of the usage rate.

18. The method for providing store information based on a digital twin according to claim 16, further comprising:
obtaining noise level measurement data for the store; and
modifying and representing geometric shape or color of the store interior elements represented in the three-dimensional virtual space according to the value of the noise level measurement data.

19. The method for providing store information based on a digital twin according to claim 16, further comprising:
obtaining interior modification design data from the server for providing store information, the interior modification design data being based on changes to the shapes and arrangements of the store interior elements in the virtual space information; and
generating virtual space change schedule information for the store based on the interior modification design data using a digital twin and transmitting the virtual space change schedule information to the first user terminal.
